(19) United States
(12) Patent Application Publication
(10) Pub. No.: US 2006/0281503 A1
(43) Pub. Date: Dec. 14, 2006

(54) Systems and methods for indicating presence for an online service with a mobile telecommunications device

(75) Inventor: Jeffrey S. Vigil, Camas, WA (US)

Correspondence Address: MADSON & AUSTIN, 15 WEST SOUTH TEMPLE, SUITE 900, SALT LAKE CITY, UT, 84101, US

(73) Assignee: Sharp Laboratories of America, Inc.

(21) Appl. No.: 11/151,095

(22) Filed: Jun. 13, 2005

(51) Int. Cl. H04M 1/00

(52) U.S. Cl. 455/575.3

(57) ABSTRACT

A mobile telecommunications device configured for use with an online service provider is disclosed that includes a processor and memory in electronic communication with the processor. Instructions are stored in the memory. The instructions are executable to implement a method for setting a presence based on a flip state of the mobile telecommunications device. The mobile telecommunications device connects to the online service provider. The flip state of the mobile telecommunications device is determined. The presence is set based on the flip state. The presence is communicated to the online service provider.

### TECHNICAL FIELD

The present invention relates generally to mobile telecommunications devices. More specifically, the present invention relates to systems and methods for indicating presence for an online service with a mobile telecommunications device.

### BACKGROUND

The use of computers in society has grown significantly over the recent decades. Computers have been increasingly integrated into homes, businesses, schools, etc. The use of computers in the business world has increased dramatically. Computers are being utilized to perform numerous business functions relating to communications, advertising, accounting, etc. Computers are also increasingly used in schools to further education. Students use computers to improve their skills in multiple subjects such as math, languages, art, etc. Similarly, computers are also being increasingly used in homes to assist in numerous tasks such as personal financing matters, correspondence, etc.

The use of computer networks has likewise increased at a rapid pace. Computer networks are a group of computers connected together in order to share information and/or tasks. There are numerous types of computer networks. One example is a local area network (LAN). Computer networks within companies allow co-workers to exchange and share information from one computer to another. Business tasks are completed at faster rates because the task may be shared by multiple computers connected to the network.

Individual computer networks may be further connected with other computer networks to create a larger network. The Internet has become the largest computer based global information system which is composed of thousands of interconnected computer networks. The dramatic increase of use of the Internet has changed the way in which society functions. The Internet allows users of computers anywhere in the world to have access to the information within this massive interconnected network.

There have been numerous services that have been provided through the Internet network to users. These “online services” allow users to have access to the information being provided over the Internet. Some online services allow users to locate and purchase merchandise that is provided through the Internet network. Other online services allow users to search for and purchase airline tickets from virtually any airline carrier that has provided ticket information through the Internet network. Online services have also changed the methods in which people may communicate. One example of this type of online service is instant messaging.

Instant messaging refers to the process of exchanging text messages between two or more people. Typically, instant messaging allows users to form a list of people with whom they wish to communicate. This list is typically called a “buddy list,” and most instant messaging services allow users to communicate with anyone on their buddy list, assuming that the person is online at that given time. Generally, users will send an alert to those persons on their buddy list who are online prior to engaging in a conversation. Most instant messaging services provide a small text window where two or more users can type messages that both users can instantly view. The parties in the conversation typically see each line of text right after it is typed (line-by-line).

Instant messaging services not only allow users to send notes back and forth while online, they can also allow users to set up chat rooms to communicate with groups of users, and to share links to web sites as well as images, audio, and the like. To some people, instant messaging seems more like a telephone conversation than exchanging letters and has become very popular for both business and personal use. Instant messaging is often used as a way to avoid telephone tag, whether the communication continues as text messages or winds up as a traditional phone call.

Many of the online services provided over the Internet use a concept referred to as presence. Presence allows the user of the online service to indicate to other users of the online service whether he/she is “on-line” or “off-line.” For example, online services such as instant messaging, use presence to indicate whether the user is on-line or off-line and the availability for communication, such as “available,” “busy,” or “out-to-lunch.” Many of these instant messaging services will automatically convey an online status when the user's computer enters a certain state. For example, an instant messaging service may automatically convey the online status of “Away” when the computer shuts down or is put in the sleep or hibernate mode. Similarly, the instant messaging service may automatically convey the online status of “Available” when the computer returns to an active state from the sleep or hibernate mode or from being powered up by a user.

In addition to these online services, the increasing rate of demand for more efficient methods of communicating with others has led to the increased use of mobile telecommunications devices, such as cellular telephones. Cellular telephones provide users the ability to communicate by telephone without the restrictions of a wire-based telephone. Cellular telephone signals allow much more mobility to users of such mobile telephones.

Some mobile telecommunications devices, such as cellular telephones, also provide users the ability to engage in the numerous online services described previously. For example, cellular telephone users may participate in the online service of instant messaging. Users of cellular telephones enjoy basically the same benefits enjoyed by users of an instant messaging service on a traditional computer. Users of cellular telephones may now engage in instant messaging with multiple members of their buddy list in virtually any location where the cell phone receives a signal. Cell phone users may also share images, audio, and the like that are stored in the cell phone memory through instant messaging.

Unfortunately, known systems and methods for engaging online services through mobile communications devices, such as cellular telephones, suffer from various drawbacks. Accordingly, benefits may be realized by improved systems and methods for using and accessing online services through cellular telephones. Similarly, benefits may be realized by improved systems and methods for the presence functionality inherit in many online services. Some exemplary systems and methods for online services through cellular telephones are described herein.

### BRIEF DESCRIPTION OF THE DRAWINGS

Exemplary embodiments of the invention will become more fully apparent from the following description and appended claims, taken in conjunction with the accompanying drawings. Understanding that these drawings depict only exemplary embodiments and are, therefore, not to be considered limiting of the invention's scope, the exemplary embodiments of the invention will be described with additional specificity and detail through use of the accompanying drawings in which:

FIG. 1 is a block diagram of an online service provider in electronic communication with various subscribers;

FIG. 2 is a block diagram illustrating the flip state of a mobile telecommunications device being used as a presence indicator;

FIG. 3 is a more particular block diagram of a mobile telecommunications device using the flip state as a presence indicator;

FIG. 4 is a functional block diagram of an embodiment of a mobile telecommunications device;

FIG. 5 is an illustration of one embodiment of a mobile telecommunications device;

FIG. 6 is an illustration of a side view of the mobile telecommunication device of FIG. 5 in a closed state;

FIG. 7 is an illustration of a side view of the mobile telecommunication device of FIG. 5 in an open state;

FIG. 8 is a flow diagram illustrating an embodiment of a method for using a flip state of a mobile telecommunications device to indicate presence; and

FIG. 9 is a flow diagram illustrating another embodiment of a method for using a flip state of a mobile telecommunications device to indicate presence.

### DETAILED DESCRIPTION

A mobile telecommunications device configured for use with an online service provider is disclosed that includes a processor and memory in electronic communication with the processor. Instructions are stored in the memory. The instructions are executable to implement a method for setting a presence based on a flip state of the mobile telecommunications device. The mobile telecommunications device connects to the online service provider. The flip state of the mobile telecommunications device is determined. The presence is set based on the flip state. The presence is communicated to the online service provider.

The mobile telecommunications device may be a cellular telephone. The cellular telephone may be a flip-style cellular telephone. In the embodiment where a flip-style cellular telephone is used, the flip state of the mobile telecommunications device may change as the flip-style cellular telephone is opened or closed. In such an implementation the presence may indicate that a user of the device is available when the flip-style cellular telephone is open, and the presence may indicate that a user of the device is not available when the flip-style cellular telephone is closed. Furthermore, the presence may automatically change based on the flip state.

The online service provider may be, but is not limited to, any of the following: an instant messaging service, a chat room service, a video conferencing service, a virtual meeting service, and a virtual whiteboard session. In the embodiment where the online service provider is an instant messaging service, the presence may be communicated to the online service provider by an instant messenger application running on the mobile telecommunications device.

Flip monitor instructions may be included in the mobile telecommunications device to determine the flip state of the mobile telecommunications device. The mobile telecommunications device may also include user settings stored in the memory, wherein the user settings include preconfigured messages for a presence indicator.

Some embodiments of the mobile telecommunications device may continue to monitor the flip state. Embodiments may also continue to update the presence based on the flip state. The device may wait a time period before changing the presence when there has been a change in the flip state.

A method for setting a presence based on a flip state of the mobile telecommunications device is also disclosed. The mobile telecommunications device connects to the online service provider. The flip state of the mobile telecommunications device is determined. The presence is set based on the flip state. The presence is communicated to the online service provider.

A system for providing presence of a mobile telecommunications device is also disclosed. An online service provider is in electronic communication with a network. The system includes a plurality of subscribers to the online service provider. A mobile telecommunications device configured for use with an online service provider includes a processor and memory in electronic communication with the processor. Instructions are stored in the memory. The instructions are executable to implement a method for setting a presence based on a flip state of the mobile telecommunications device. The mobile telecommunications device connects to the online service provider. The flip state of the mobile telecommunications device is determined. The presence is set based on the flip state. The presence is communicated to the online service provider. The online service provider receives the presence from the mobile telecommunications device and sends the presence to one or more of the plurality of subscribers.

Various embodiments of the invention are now described with reference to the Figures, where like reference numbers indicate identical or functionally similar elements. The embodiments of the present invention, as generally described and illustrated in the Figures herein, could be arranged and designed in a wide variety of different configurations. Thus, the following more detailed description of several exemplary embodiments of the present invention, as represented in the Figures, is not intended to limit the scope of the invention, as claimed, but is merely representative of the embodiments of the invention.

The word “exemplary” is used exclusively herein to mean “serving as an example, instance, or illustration.” Any embodiment described herein as “exemplary” is not necessarily to be construed as preferred or advantageous over other embodiments. While the various aspects of the embodiments are presented in drawings, the drawings are not necessarily drawn to scale unless specifically indicated.

Many features of the embodiments disclosed herein may be implemented as computer software, electronic hardware, or combinations of both. To clearly illustrate this interchangeability of hardware and software, various components will be described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Where the described functionality is implemented as computer software, such software may include any type of computer instruction or computer executable code located within a memory device and/or transmitted as electronic signals over a system bus or network. Software that implements the functionality associated with components described herein may comprise a single instruction, or many instructions, and may be distributed over several different code segments, among different programs, and across several memory devices.

The present systems and methods enable the presence setting for a user of an online service that is using the service with a flip-style mobile telecommunications device to be set automatically by detecting whether the flip-style device is open or closed (the state of the flip in a flip-phone). Online services such as instant messaging use a concept called presence. Presence indicates whether the user is “on-line” or “off-line” and the availability for communication, such as “available”, “busy” or “out-to-lunch”. These services have become popular on the Internet as well as mobile handsets.

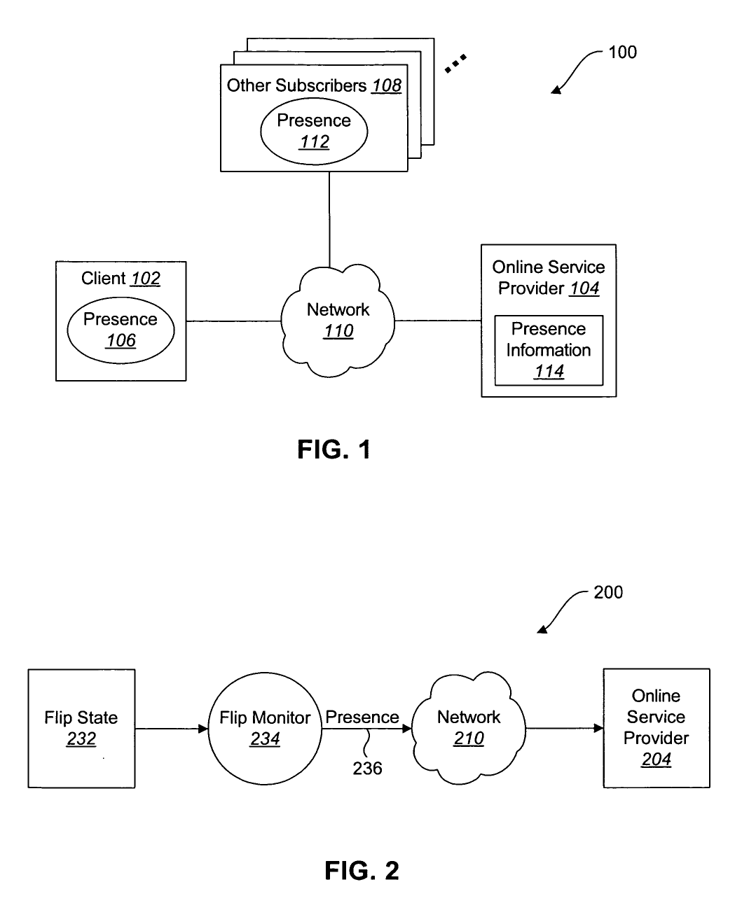

FIG. 1 is a block diagram of a system 100 that includes an online service provider 104 in electronic communication with various subscribers. One particular subscriber is illustrated as the client 102. When connected to and/or using the online service, the client has a presence 106. The presence 106 of the client 102 is communicated to the online service provider 104, which may then propagate the presence 106 of the client 102 to other subscribers 108 as needed.

The online service provider 104 is providing some service via the network 110 where presence is communicated to one or more subscribers 108. The subscribers 108, including the client 102 (the client 102 is also a subscriber to the online service), illustrated in the embodiment of FIG. 1 each have a presence 112, 106 which is communicated to the online service provider 104. The online service provider 104 stores and manages the presence information 114 of its subscribers 108, 102 and sends presence information 114 to subscribers 108, 102 as needed.

One example of an online service provider 104 is an instant messaging service. Other examples include, but are not limited to, chat room services, video conferencing services, virtual meeting services, virtual whiteboard sessions, and the like.

The online service provider 104 is accessed via a communications network 110. The network 110 depicted in FIG. 1 may be embodied in a wide variety of configurations and may include a combination of multiple networks. The network 110 may include, for example, a cellular telephone network, a local area network (LAN), storage area networks (SANs), metropolitan area networks (MANs), wide area networks (WANs), and combinations thereof (e.g., the Internet). One combination of networks that may comprise the communications network 110 of FIG. 1 includes a cellular telephone network and the Internet.

Subscribers 108 typically include some form of computing device capable of connecting to the online service provider 104. A computing device, as used herein, is any device that includes a digital processor capable of receiving and processing data. A computing device includes the broad range of digital computers including microcontrollers, hand-held computers, mobile telecommunications devices, personal digital assistants, personal computers, servers, mainframes, supercomputers, and any variation or related device thereof.

The types of subscribers 108, 102 include mobile telecommunications devices, as will be more fully discussed below. Generally speaking, one type of mobile telecommunications device includes a flip mechanism or style. With a flip-style phone, typically the flip-phone is open when in use and closed when not in use. The systems and methods herein combine the ability of the handset to monitor the flip state, and provide that information to an application executing on the handset, with the application's ability to maintain a presence state to an online service.

FIG. 2 is a block diagram 200 illustrating the flip state 232 of the mobile telecommunications device (not shown in FIG. 2) being used as a presence indicator 236 for the online service provider 204. A flip monitor 234 monitors the flip state 232. The flip monitor 234 causes the presence indicator 236 to be communicated to the online service provider 204 via the communications network 210.

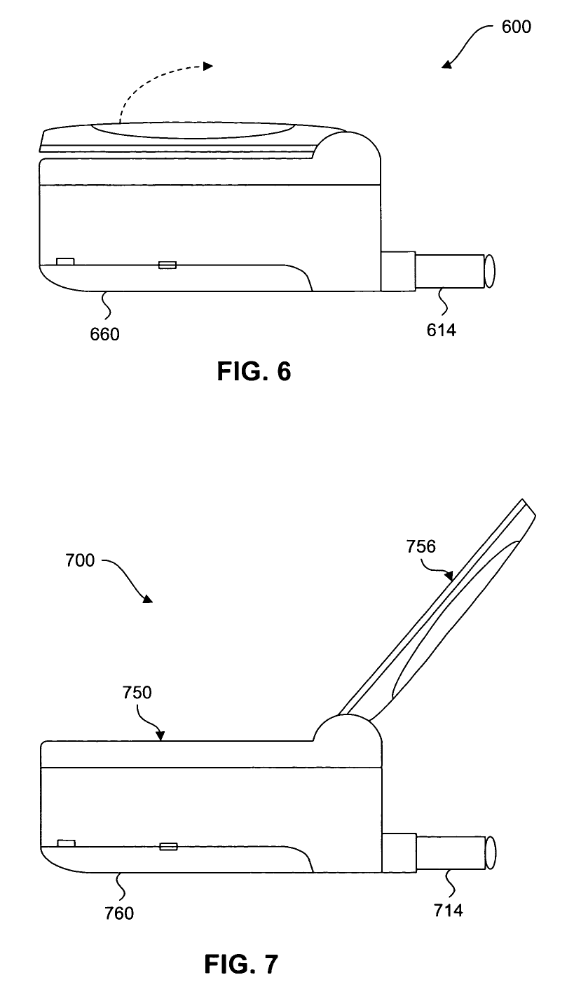

The flip state 232 indicates whether the mobile telecommunications device is open or closed. The change of the flip-phone position from open to closed or closed to open causes the flip state 232 to change accordingly. The flip monitor 234 includes executable instructions that monitor the flip state 232 and cause the presence indicator 236 to change according to the flip state 232. This presence 236 is then communicated via the communications network 210 to the online service provider 204. A further discussion and illustration of the flip-phone positions is included with respect to FIGS. 6 and 7.

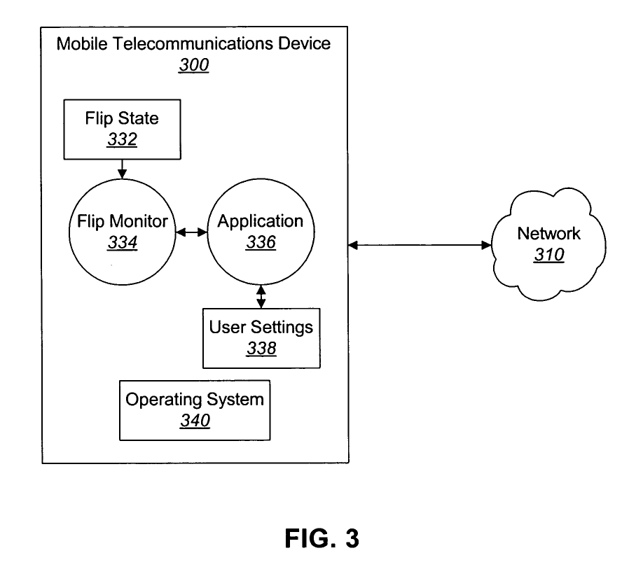

FIG. 3 is a more particular block diagram of a mobile telecommunications device 300 using the flip state 332 to drive a presence indicator for an online service. This embodiment 300 illustrates the flip monitor 334 monitoring the flip state 332. The flip monitor 334 communicates the flip state 332 to an application 336 on the mobile telecommunications device 300.

The application 336 on the mobile telecommunications device 300 is a client application 336 for the online service provider 104. In the embodiment where instant messaging is the online service, the application 336 may be the instant messenger program that is running on the mobile telecommunications device 300. The application 336 updates the presence for the device 300 and sends it to the online service provider via the network 310.

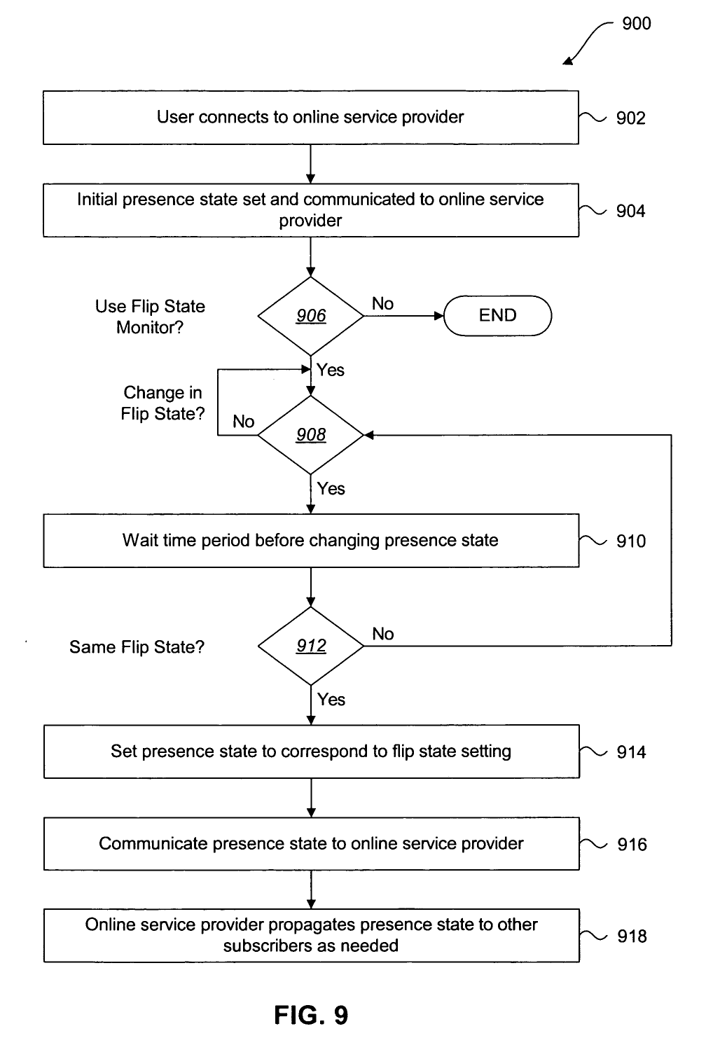

User settings 338 on the mobile telecommunications device 300 may be used to configure particular messages for the presence indicator 236. In addition, user settings 338 may also be used to turn the flip state presence indication (or flip state presence mode) on and off. In other words, the user settings 338 may include data that indicates whether the user wants to enable the present systems and methods that allow the presence to be set by the flip state of the device 300. There may be situations where the user does not want the presence to be set by the flip state of the device 300. Waiting time periods, as discussed below with respect to FIG. 9, may also be configured and stored in the user settings 338.

Typically, modern mobile telecommunications devices 300 include an operating system 340 for the device 300. The application 336 executes on the operating system 340 to communicate with the online service provider 104 via the network 310.

Since a closed flip indicates the user of the device 300 is not able or not actively engaged or unavailable, the application 336 on the device 300 may detect this flip state 332 and automatically set the presence state in the online service. When the flip is open it can be assumed the user is interactively engaged so he or she is “available”. If the user closes the flip, the user is not available and the application 336 may set the presence to “unavailable” or “busy” or some other, previously defined, user provided description (which may be stored in the user settings 338). This allows the presence to be easily and quickly set by the state of the flip. Thus the user does not need to navigate through a variety of dialogs and menus to set the availability every time they are distracted from their device 300. A client application 336 using this concept will likely allow the user to enable or disable this automatic feature and be able to set the “unavailable” message ahead of time to a meaningful description, such as “busy” or “out to lunch”. The user settings 338 may be used to set descriptions.

As mentioned, one possible online service is instant messaging. In order to use instant messaging, a user logs in to a messaging server using the instant messaging application (client) executing on the handset. Part of this online service is “presence”. This indicates “online” or “offline”, and if “online” the availability such as “available”, “unavailable” or “busy”. The client application maintains this state with the instant messaging server according to user preference.

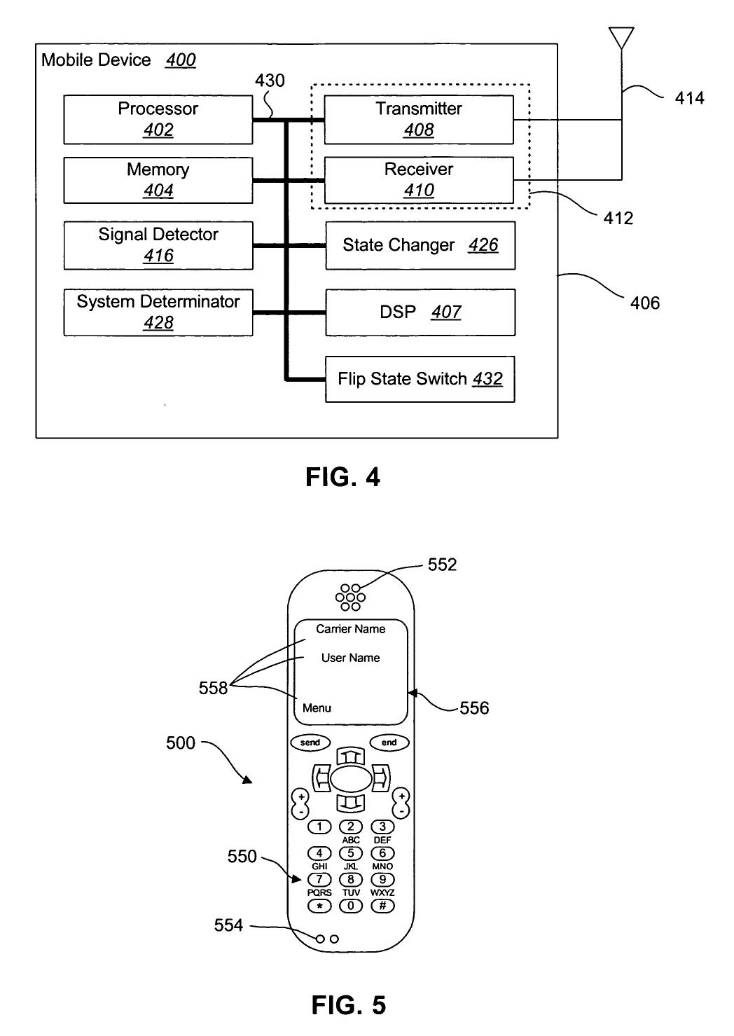

The mobile telecommunications device, in one embodiment, is a cellular telephone. An embodiment of a mobile telecommunications device 400 is illustrated in the functional block diagram of FIG. 4. The system 400 includes a processor 402 that controls operation of the system 400. The processor 402 may also be referred to as a CPU. Memory 404, which may include both read-only memory (ROM) and random access memory (RAM), provides instructions and data to the processor 402. A portion of the memory 404 may also include non-volatile random access memory (NVRAM).

The system 400 also includes a housing 406 that contains a transmitter 408 and a receiver 410 to allow transmission and reception of data, such as audio communications, between the system 400 and a remote location, such as a cell site controller or base station. The transmitter 408 and receiver 410 may be combined into a transceiver 412. An antenna 414 is attached to the housing 406 and electrically coupled to the transceiver 412. Additional antennas (not shown) may also be used. The operation of the transmitter 408, receiver 410 and antenna 414 is well known in the art and need not be described herein.

The system 400 also includes a signal detector 416 used to detect and quantify the level of signals received by the transceiver 412. The signal detector 416 detects such signals as total energy, pilot energy per pseudonoise (PN) chips, power spectral density, and other signals, as is known in the art.

A state changer 426 of the system 400 controls the state of the wireless communication device based on a current state and additional signals received by the transceiver 412 and detected by the signal detector 416. The system 400 also includes a system determinator 428 used to control the wireless communication device and determine which service provider system the wireless communication device should transfer to when it determines the current service provider system is inadequate.

The various components of the system 400 are coupled together by a bus system 430 which may include a power bus, a control signal bus, and a status signal bus in addition to a data bus. However, for the sake of clarity, the various busses are illustrated in FIG. 4 as the bus system 430. The system 400 may also include a digital signal processor (DSP) 407 for use in processing signals. One skilled in the art will appreciate that the system 400 illustrated in FIG. 4 is a functional block diagram rather than a listing of specific components.

The system 400 may also include a flip state switch 432. The flip state switch 432 is hardware in the system that detects the state of the flip phone, whether open or closed. The flip state switch 432 may also cause a flip state in software to be set accordingly. It is also possible that the flip state switch 432 may be read directly by a flip monitor 334. In some embodiments the flip state switch 432 may be a switch mechanism which detects, for the handset software, the state of the flip—open or closed. A typical use of this is to turn on or off the backlighting of the display according to the flip state 332.

In the systems herein an application executing on the cell phone has access to this flip state. This application would be one that is associated with an online service, such as instant messaging, as is used in this example.

The methods disclosed herein may be implemented in an embodiment of a mobile device 400. In one embodiment, the methods described herein may be implemented through executable instructions stored in the memory 404 and executed by the processor 402.

FIG. 5 is an illustration of one embodiment of a mobile device 500. Mobile devices 500 typically include a number of buttons 550 or keys 550 that the user may use in operating the mobile device 500. The mobile device 500 also includes a speaker 552 and a microphone 554. A display 556 is used to provide messages 558 to the user.

One example of a mobile device that may be used is a clamshell (flip-phone) style, GSM mobile phone similar to the Sharp TM150 handset (not shown). It has a loudspeaker on the outside of the cabinet, used for playing ringtones and music, and an earpiece and microphone on the inside that are accessible when the handset is opened, similar to the embodiment shown in FIG. 5.

FIG. 6 is a side view of a mobile telecommunication device 600 that is a flip-style phone. The flip-style phone 600 in FIG. 6 is in the closed state. As a result, the flip state in this embodiment 600 would indicate that the phone is closed. Using the present systems and methods the presence of this device 600 may accordingly be set to “away”, “unavailable”, “busy”, etc. FIG. 6 also illustrates the antenna 614 and the battery 660 of the device 600.

FIG. 7 is a side view of a mobile telecommunication device 700 that is a flip-style phone in an open state. As a result, the flip state in this embodiment 700 would indicate that the phone is open. Using the present systems and methods the presence of this device 700 would accordingly be set to “available” or the like. FIG. 7 also illustrates the antenna 714 and the battery 760 of the device 700. When the phone 700 is open, the display 756 and the keypad 750 are exposed.

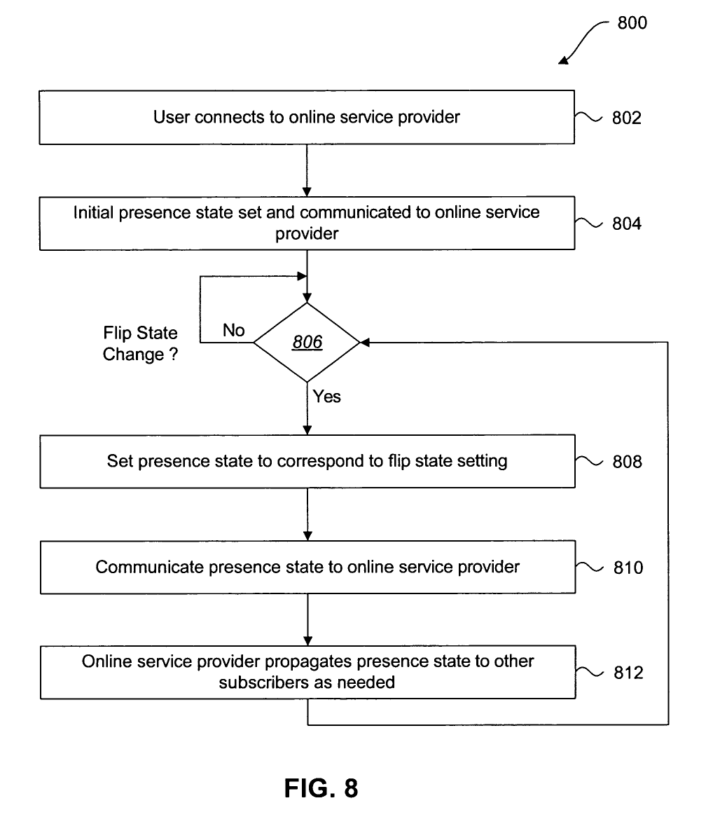

FIG. 8 is a flow diagram illustrating an embodiment of a method 800 for using a flip state 332 of a mobile telecommunications device 300 to indicate presence. The user of the mobile telecommunications device 300 connects 802 to an online service provider 104. The initial presence state is set 804 and communicated to the online service provider 104. Then it is determined 806 if there was a change in the flip state 332 of the device 300. If there was not a change in the flip state 332 of the device 300, then the flip monitor 334 simply continues to monitor the flip state 332 to determine 806 if there was a change in the flip state 332.

If there was a change in the flip state 332, then the presence state is set 808 to correspond to the flip state 332 setting. The new presence state is then communicated 810 to the online service provider 104. The online service provider 104 propagates 812 the presence state to other subscribers as needed.

FIG. 9 is a flow diagram illustrating another embodiment of a method 900 for using a flip state 332 of a mobile telecommunications device 300 to indicate presence. The user of the mobile telecommunications device 300 connects 902 to an online service provider 104. The initial presence state is set 904 and communicated to the online service provider 104. It is determined 906 if the flip state monitor 334 is being used to set the presence. If it is, then the process continues as shown. If it is not, the process ends. In some embodiments the user of the device 300 may configure the mobile telecommunications device 300 to use the flip state monitor 334 to set the presence, or he or she may turn off the flip state presence mode. If the flip state presence mode of the device 300 is turned off, the steps for accomplishing the flip state presence mode do not need to be followed and, as a result, the process ends.

Assuming that the flip state presence mode of the device 300 is turned on, then it is determined 908 if there was a change in the flip state 332 of the device 300. If there was not a change in the flip state 332 of the device 300, then the flip monitor 334 simply continues to monitor the flip state 332 to determine 908 if there was a change in the flip state 332.

If there was a change in the flip state 332, then the device 300 may wait 910 some period of time before changing the presence state. This embodiment with timing functionality may be used so that the change in presence will be made after some amount of time since the change in flip state 332. For example 30 seconds after closing the flip the presence will change to unavailable. This will avoid frequent or unnecessary changes to presence. After the period of time it is determined 912 whether the flip state 332 is in the same state that caused the wait step 910 to be entered. If it is, then the presence state is set 914 to correspond to the flip state 332 setting. If the flip state 332 has changed, then the method returns to the step of monitoring 908 the flip state 332, as shown.

The new presence state is then communicated 916 to the online service provider 104. The online service provider 104 propagates 918 the presence state to other subscribers as needed.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array signal (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The methods disclosed herein comprise one or more steps or actions for achieving the described method. The method steps and/or actions may be interchanged with one another without departing from the scope of the present invention. In other words, unless a specific order of steps or actions is required for proper operation of the embodiment, the order and/or use of specific steps and/or actions may be modified without departing from the scope of the present invention.

While specific embodiments and applications of the present invention have been illustrated and described, it is to be understood that the invention is not limited to the precise configuration and components disclosed herein. Various modifications, changes, and variations which will be apparent to those skilled in the art may be made in the arrangement, operation, and details of the methods and systems of the present invention disclosed herein without departing from the spirit and scope of the invention.

What is claimed is:

1. A mobile telecommunications device that is configured for use with an online service: provider, comprising:
a processor;
memory in electronic communication with the processor; and
instructions stored in the memory, the instructions being executable to implement a method for setting a presence based on a flip state of the mobile telecommunications device comprising:
connecting to the online service provider;
determining the flip state of the mobile telecommunications device;
setting the presence based on the flip state; and
communicating the presence to the online service provider.

2. The mobile telecommunications device of claim 1, wherein the mobile telecommunications device comprises a cellular telephone.

3. The mobile telecommunications device of claim 2, wherein the cellular telephone is a flip-style cellular telephone.

4. The mobile telecommunications device of claim 3, wherein the flip state of the mobile telecommunications device changes as the flip-style cellular telephone is opened or closed.

5. The mobile telecommunications device of claim 4, wherein the presence indicates that a user of the device is available when the flip-style cellular telephone is open and wherein the presence indicates that a user of the device is not available when the flip-style cellular telephone is closed.

6. The mobile telecommunications device of claim 1, wherein the online service provider is selected from the group consisting of an instant messaging service, a chat room service, a video conferencing service, a virtual meeting service, and a virtual whiteboard session.

7. The mobile telecommunications device of claim 6, wherein the presence is communicated to the online service provider by an instant messenger application running on the mobile telecommunications device.

8. The mobile telecommunications device of claim 1, further comprising flip monitor instructions that are executed to determine the flip state of the mobile telecommunications device.

9. The mobile telecommunications device of claim 1, further comprising user settings stored in the memory, wherein the user settings comprise preconfigured messages for a presence indicator.

10. The mobile telecommunications device of claim 1, wherein the mobile telecommunications device comprises a flip-style cellular telephone, and wherein the flip state of the mobile telecommunications device changes as the flip-style cellular telephone is opened or closed, and wherein the presence is automatically changed based on the flip state.

11. The mobile telecommunications device of claim 1, wherein the method implemented by the executable instructions further comprises continuing to monitor the flip state.

12. The mobile telecommunications device of claim 11, wherein the method implemented by the executable instructions further comprises continuing to update the presence based on the flip state.

13. The mobile telecommunications device of claim 12, wherein the method implemented by the executable instructions further comprises waiting a time period before changing the presence when there has been a change in the flip state.

14. In a mobile telecommunications device, a method for setting a presence based on a flip state of the mobile telecommunications device comprising:
connecting to an online service provider;
determining the flip state of the mobile telecommunications device;
setting the presence based on the flip state; and
communicating the presence to the online service provider.

15. The method of claim 14, wherein the mobile telecommunications device comprises a flip-style cellular telephone.

16. The method of claim 15, wherein the presence indicates that a user of the device is available when the flip-style cellular telephone is open and wherein the presence indicates that a user of the device is not available when the flip-style cellular telephone is closed.

17. The method of claim 16, wherein the online service provider is selected from the group consisting of an instant messaging service, a chat room service, a video conferencing service, a virtual meeting service, and a virtual whiteboard session.

18. A system for providing presence of a mobile telecommunications device, the system comprising:
an online service provider that is in electronic communication with a network;
a plurality of subscribers to the online service provider; and
a mobile telecommunications device that is configured for use with the online service provider, comprising:
a processor;
memory in electronic communication with the processor; and
instructions stored in the memory, the instructions being executable to implement a method for setting a presence based on a flip state of the mobile telecommunications device comprising:
connecting to the online service provider;
determining the flip state of the mobile telecommunications device;
setting the presence based on the flip state; and
communicating the presence to the online service provider; and
wherein the online service provider receives the presence from the mobile telecommunications device and sends the presence to one or more of the plurality of subscribers.

19. The system of claim 18, wherein the mobile telecommunications device comprises a flip-style cellular telephone.
